(19) United States
(12) Patent Application Publication
(10) Pub. No.: US 2002/0124181 A1
(43) Pub. Date: Sep. 5, 2002

(54) Method for providing vaccine software and program

(76) Inventor: Masaya Nambu, Nagoya-shi (JP)

Correspondence Address: STAAS & HALSEY LLP, 700 11TH STREET, NW, SUITE 500, WASHINGTON, DC, 20001, US

(21) Appl. No.: 09/892,751

(22) Filed: Jun. 28, 2001

(30) Foreign Application Priority Data
Mar. 5, 2001 (JP) 2001-060570

(51) Int. Cl. G06F 11/30

(52) U.S. Cl. 713/200

(57) ABSTRACT

A method for providing virus vaccine software that prevents devices from being infected by new viruses. A maintenance server receives virus countering information from a terminal of at least one vaccine software maker and receives vaccine software-related information from a user terminal. The maintenance server confirms whether the user terminal is capable of countering a new virus from the virus countering and vaccine software-related information. When the vaccine software presently used by the user terminal does not correspond to the new virus and the user wishes to be provided with updated vaccine software, the maintenance server distributes a vaccine software capable of countering the new virus to the user terminal.

### BACKGROUND OF THE INVENTION

The present invention relates to a method for providing vaccine software and a program, and more particularly, to a method for providing vaccine software and a program that prevent computers from being infected by new types of computer viruses.

Generally, in computer systems, it is required that when a system fault occurs, the fault be treated so that it does not occur again regardless of whether or not the cause of the fault is identified.

Nowadays, computer viruses (hereafter simply referred to as viruses) cause many faults. Thus, it is necessary for updated anti-virus software (vaccine software) Lo be installed in the computer software as soon as possible.

In this specification, the term “fault recovery information” indicates information regarding the cause of a fault and information regarding a fault recovery operation. Further, hereinafter, a client-server system in a multi-vendor environment is used as an example of a computer system.

FIG. 1 is a block diagram illustrating how a fault is processed in a conventional client-server system 500. A client PC 1 includes company A's middleware 11 (programs such as a database management system, a communication management system, a software development assisting tool, a word processing program, and a graphic processing program), a monitor program 12, and an information collecting/informing program 13. A server 2 includes a fault inquiry program 21, a fault management database 22, a resource distributing program 23, and company A's middleware 24.

A conventional procedure for processing faults will now be discussed.

(S31) The monitor program 12 detects a fault caused by the client-side middleware 11, which is being executed by the client PC 1, and informs the information collecting/informing program 13 of the fault.

(S32) The information collecting/informing program 13 collects information regarding contents of various definition files of the client PC 1 and information regarding the program that is being executed by the client PC 1. The information collecting/informing program 13 then sends the information to the server 2 as fault-related information.

(S33) The fault inquiry program 21 of the server 2 attempts to identify a cause of the fault that corresponds to the fault-related information by referring to the fault management database 22. If the cause of the fault is identified, the fault inquiry program 21 informs the information collecting/informing program 13 of the cause. In contrast, if the cause is not identified, the fault inquiry program 21 does not send any response to the information collecting/informing program 13.

As described above, in the conventional fault recovery process, if the fault inquiry program (fault recovery section) 21 of the server 2 cannot identify the cause of the fault, the server 2 does not send any fault recovery information to the client PC 1 (program executing device).

Thus, the client PC 1 is not allowed to proceed to the fault recovery process. As a result, the fault is reproduced when, subsequent to recovery, the client PC 1 enters the same program executing environment as that during which the fault occurred.

Computer viruses that cause many faults in systems may be included in data and programs or data and programs attached to e-mail. Such viruses may enter a user terminal (computer system) and cause a fault in the terminal viruses may also be included in programs installed from the internet or from CD-ROMs.

Therefore, anti-virus software (vaccine software) is installed in computer systems. The vaccine software includes pattern files (pattern data) that store data for detecting various types of viruses. When a portion of the checked data (or program) matches a certain pattern, the vaccine software determines that the portion of the matching data is a virus (or includes virus) and eliminates the virus or issues a warning.

Since new viruses are constantly generated, the user must update the vaccine software and the pattern files. Thus, the user must download programs and data from the provider of the vaccine software and pattern files to update the vaccine software and the pattern files.

However, when a new type of virus is generated, the maker may require two to three days to prepare a program and data that identifies the new virus. Another few days may be necessary until the user installs in his computer system the program and data corresponding to the new virus.

In the prior art, makers do not send information to user terminals on how to identify new viruses unless the vaccine software installed in the computer system is updated and capable of handling the new viruses. Thus, when, for example, a terminal user inadvertently opens an e-mail message sent from an unidentified sender, the terminal may bo infected by the new virus.

### SUMMARY OF THE INVENTION

It is a first object of the present invention to provide a method for providing a vaccine software and a program that prevents faults from reoccurring when the cause of the fault cannot be identified.

It is a second object of the present invention to provide a method for providing a vaccine software and a program that prevents computers from being infected by new viruses.

To achieve the above object, the present invention provides a method for providing virus vaccine software to a user terminal with a maintenance server that includes a first memory for storing information related to how a new virus is countered and a second memory for storing user information. The method includes receiving virus countering information from a terminal of at least one vaccine software maker and storing the received virus countering information in the first memory, receiving vaccine software-related information from at least one user terminal and storing the received vaccine software-related information in the second memory, receiving the vaccine software-related information of a user from the second memory, receiving new virus countering information from the first memory based or the vaccine software-related information, and distributing vaccine software that corresponds to the new virus to the user terminal when the vaccine software presently used by the user terminal does not correspond to the new virus and the user wishes to be provided with updated vaccine software.

A further perspective of the present invention is a program for operating a computer that provides virus vaccine software to at least one user terminal. The program causes the computer to define a first memory means for receiving virus countering information from a terminal of at least one vaccine software maker and storing the received virus countering information, a second memory means for receiving vaccine software-related information from at least one user terminal and storing the received vaccine software-related information, and a new anti-virus processing means for receiving the vaccine software-related information of the user terminal from the second memory means and receiving the new virus countering information from the first memory means based on the received vaccine software-related information. The new anti-virus processing means generates information to distribute to the user terminal updated vaccine software corresponding to the new virus when the vaccine software presently used by the user terminal does not correspond to the new virus and the user wishes to be provided with the updated vaccine software. The method further includes a resource distributing means for receiving the information from the new anti-virus processing means and distributing the updated vaccine software that corresponds to the new virus based on the information.

A further perspective of the present invention is a method for providing a virus software to at least one user terminal using a first memory for storing information related to how a new virus is countered and a second memory for storing user information. The method includes receiving virus countering information from a terminal of at least one vaccine software maker and storing the received virus countering information in the first memory, receiving vaccine software-related information of a user from the user terminal and storing the received vaccine software-related information in the second memory, receiving the vaccine software-related information from the second memory, receiving new virus countering information from the first memory based on the vaccine software-related information, distributing vaccine software that corresponds to the new virus to the user terminal when the vaccine software presently used by the user terminal does not correspond to the new virus and the user wishes to be provided with updated vaccine software.

A further perspective of the present invention is a method for recovering from a fault when a fault occurs during execution of a first program. The method includes receiving fault-related information from the computer executing the first program, investigating a cause of the fault from the fault-related information, and instructing the computer to replace the first program with a second program when the cause of the fault is unidentified.

A further perspective of the present invention is a system for recovering from a fault when a fault occurs during the execution of a first program. The system includes a fault recovery portion for receiving fault-related information from a computer. The fault recovery portion investigates a cause of the fault from the fault-related information and instructs the computer to replace the first program with a second program when the cause of the fault is unidentified.

A further perspective of the present invention is a recording medium for recording a computer readable fault recovery program that sends fault recovery information to a computer when a fault occurs in the computer during execution of a first program. The fault recovery program includes receiving fault-related information from the computer, investigating a cause of the fault from the fault-related information, and sending information instructing the computer to replace the first program with a second program when the cause of the fault is unidentified as the fault recovery information.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram illustrating a fault recovering process performed by a prior art client server system;

FIG. 2 is a block diagram illustrating a software structure of a client server system according to a first embodiment of the present invention;

FIG. 3 is a flowchart illustrating a fault recovering process performed when a client PC executes a program;

FIG. 4 is a schematic perspective view showing a computer system that executes a program read from a computer readable recording medium;

FIG. 5 is a block diagram illustrating a software structure of a client server system according to a second embodiment of the present invention;

FIG. 6 is a schematic table illustrating corresponding condition information used in the system of FIG. 5;

FIG. 7 is a schematic table illustrating user-related information used in the system of FIG. 5;

FIG. 8 is a block diagram illustrating the installation of vaccine software and pattern files in the system of FIG. 5; and

FIG. 9 is a block diagram illustrating the installation of vaccine software and pattern files in the system of FIG. 8.

### DETAILED DESCRIPTION OF THE PREFERRED EMBODIMENTS

In the drawings, like numerals are used for like elements throughout.

In a first embodiment according to the present invention, when the cause of a fault cannot be identified by a fault recovery portion, which receives fault-related information from a program executing portion (fault occurring portion), the fault recovery portion instructs the fault occurring portion to use another program, which can replace the fault occurrence program, and distributes the other program. This prevents faults, the causes of which are unidentified, from occurring again. more specifically, the first embodiment is performed in the manner described below.

(1) When a fault occurs during execution of a program, a fault recovery portion, which receives fault-related information, performs a fault recovery process to send recovery information, which corresponds to cause-related information, to a program executing portion. During the fault recovery process, the fault recovery portion instructs the fault occurring portion to use another program, which can replace the fault occurrence program, and distributes the other program when the cause of a fault is unknown.

(2) The fault recovering portion provides the fault occurring portion with the other program, which replaces the fault occurrence program.

In the present invention, as described in paragraph (1), when the fault occurrence portion cannot identify the cause of a fault from the fault-related information, which is sent from the fault occurring portion, the fault recovery portion instructs the fault occurrence portion to use the other program, which can replace the program that caused the fault. This prevents the same faults from occurring subsequently during the execution of the program.

Further, as described in paragraph (2), the fault recovery portion distributes the other program, which replaces the fault occurrence program, to the fault occurrence portion. This facilitates the installation of the other program.

The first embodiment is applied to a program, which enables a computer to perform each of the above functions, and a computer readable recording medium, which stores such program.

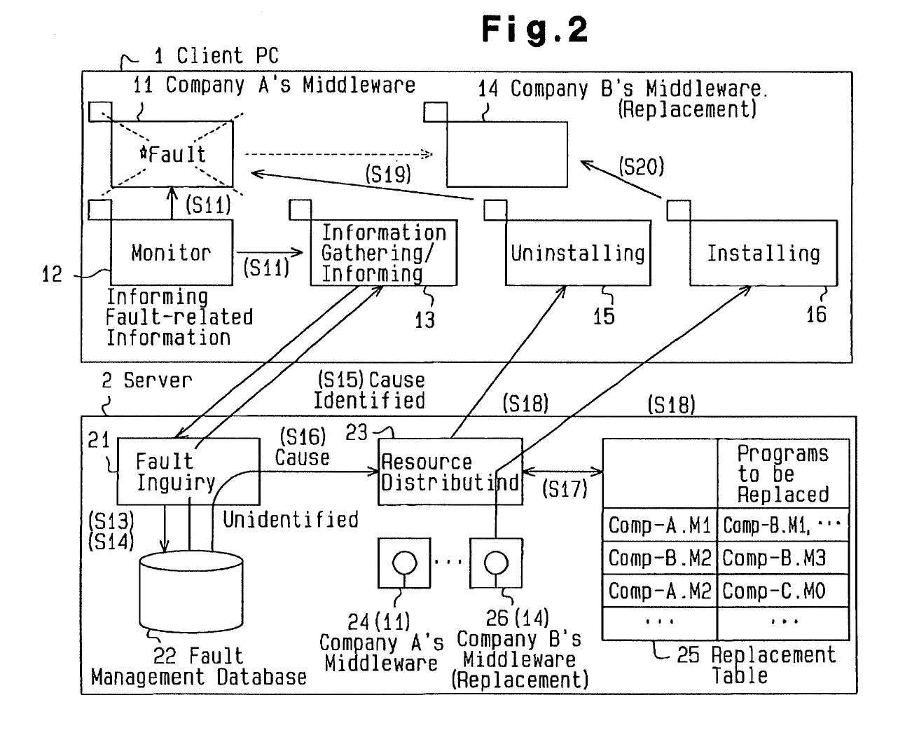

A software structure of a client server system 100 according to a first embodiment of the present invention will now be described with reference to FIG. 2.

Referring to FIG. 2, a client PC 1 includes company A's m-ddleware 11, which is executed by the client PC 1, a monitor program 12, an information collecting/informing program 13, company B's middleware 14, an uninstalling program 15, and an installing program 16. The company B's middleware 14 replaces the company A's middleware 11 based on an instruction from the server when a fault occurs during the execution of the company A's middleware 11.

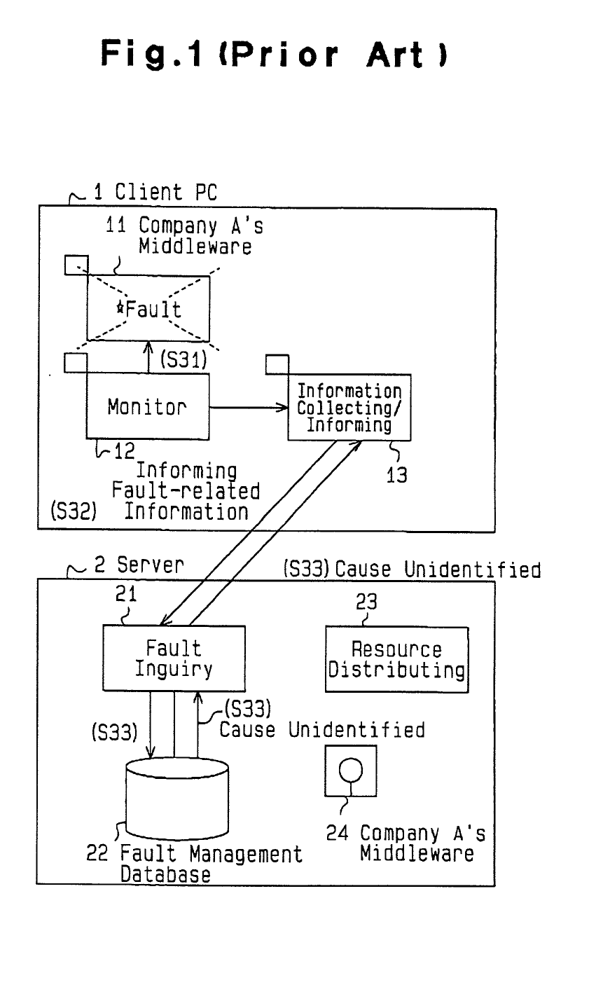

A server 2 includes a fault inquiry program 21, a fault management database 22, a resource distributing program 23, company A's middleware 24 (which is equivalent to the company A's middleware 11), a replacement table 25, and company B's middleware 26 (which is equivalent to the company B's middleware 14). The replacement table 25 indicates replaceable middleware. The company B's middleware 26 is capable of replacing the company A's middleware 24, The fault inquiry program 21 and the resource distributing program 23 form a fault recovery portion. The elements newly added to the structure of FIG. 1 in FIG. 2 are as follows:

The company B's middleware 14, the uninstalling program 15, and the installing program 16 of the client PC 1.

The replacement table 25 and the company B's middleware 26 of the server 2.

The fault management database 22 stores data indicating the relationship between fault-related information (information regarding contents of definition files of the client PC 1 and information regarding the program executed by the client PC 1) and the cause of a fault. The replacement table 25 stores a list of replaceable middleware.

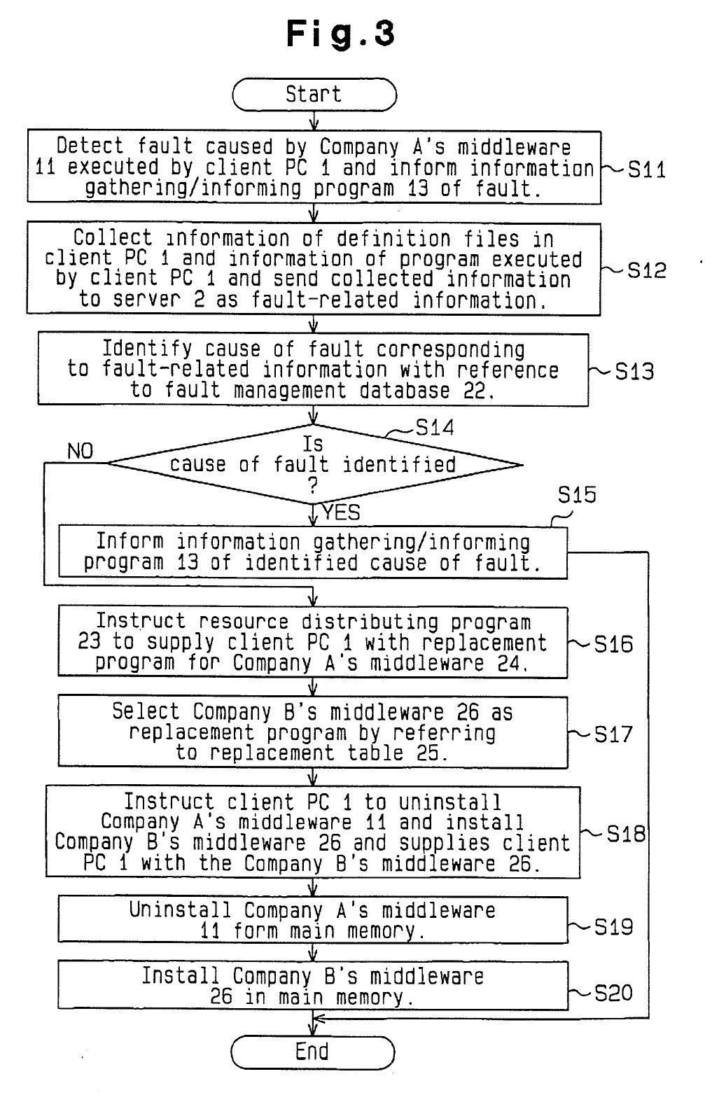

FIG. 3 is a flowchart indicating a fault recovery process performed when a fault occurs during execution of a program by the client PC.

At step S11, the monitor program 12 detects a fault caused by the A company's middleware 11, which is being executed by the client PC 1, and informs the information collecting/informing program 13 of the fault.

At step S12, the information collecting/informing program 13 collects information about the contents of definition files of the client PC 1 and information about the program being executed by the client PC 1. The information collecting/informing program 13 sends the collected information to the server 2 as fault-related information.

Then, at step S13, the fault inquiry program 21 attempts to identify a cause of the fault that corresponds to the fault-related information, by referring to the fault management database 22. The fault recovery process then proceeds to the subsequent step.

Then, at step 514, the fault inquiry program 21 determines whether or not the cause of the fault has been identified by referring to the fault management database 22. If it is determined that the cause has been identified, the fault inquiry program 21 proceeds to step S15, and if not, the fault inquiry program 21 proceeds to step S16.

At step S15, the fault inquiry program 21 informs the information collecting/informing program 13 of the identified cause of the fault.

At step S16, the fault inquiry program 21 determines that there is a problem in the compatibility of the client PC1 and the company A's middleware 11. The fault inquiry program 21 thus instructs the resource distributing program 23 to provide the client PC1 with a program to replace the company A's middleware 24.

Then, at step S17, the resource distributing program 23 refers to the replacement table 25 to select the company B's middleware 26 as the program to replace the company A's middleware 24.

Then, at step S18, the resource distributing program 23 instructs the client PC 1 to uninstall the company A's middleware 11 and install the company B's middleware 26. The resource distributing program 23 also distributes the company B's middleware 26 to the resource distributing program 23.

Then, at step S19, the uninstalling program 15 uninstalls the company A's middleware 11 from a main memory (not shown) of the client PC 1.

Then, at step S20, the installing program 16 installs company B's middleware 26 distributed by the server 2, in the main memory (not shown) of the PC 1.

The server 2 does not necessarily have to distribute the company B's middleware 26 to the client PC 1. The replacement middleware programs registered in the replacement table 25 may include software produced by the same manufacturer (in this case, company A). Further, memory-dump information of the client PC 1 may be used as the fault-related information.

The present invention may be applied to various types of computer systems (e.g., peer-to-peer type computer system or stand-alone type computer system) or other types of programs.

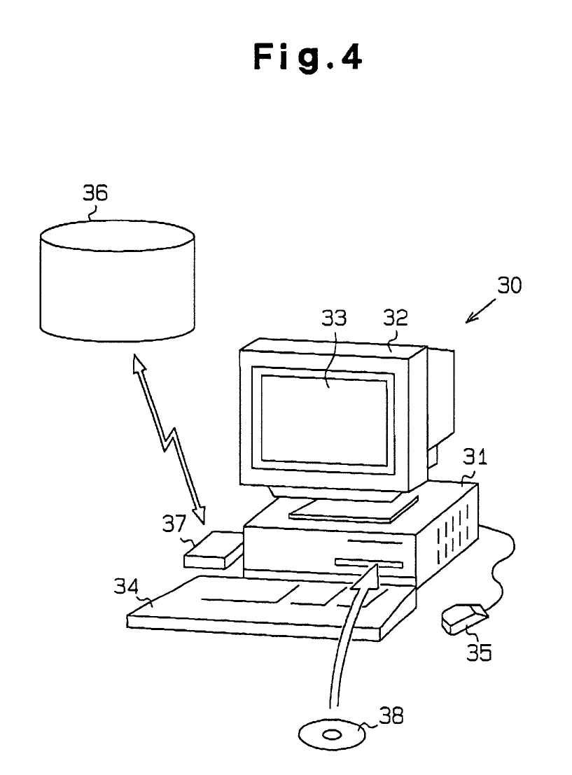

FIG. 4 is a schematically perspective view showing a computer system 30 that executes programs read from a computer-readable recording medium.

The computer system 30 includes a main unit 31, a display 32, a monitor screen 33, a keyboard 34, a mouse 35, a modem 37, and a portable recording medium 38.

The main unit 31 incorporates a CPU and a disk drive device. The main unit 31 instructs the display 32 to display an image on the monitor screen 33. The keyboard 34 is used for inputting information to the computer system 30. The mouse 35 is used to designate a certain position on the monitor screen 33. An external database (memory such as DASD) 36 is accessed through the modem 37. The portable recording medium 38 may be, for example, a CD-ROM and a floppy disk.

The recording medium that stores the fault recovery program may be the database 36 of the program provider, the portable recording medium 38, or a memory incorporated in the main unit 31. The fault recovery program is loaded to the main unit 31 and executed by the main memory of the main unit 31.

The client server system 100 of the first embodiment has the advantages described below.

(1) If the fault recovering portion cannot identify the cause of a fault, the fault recovering portion instructs the program executing device to use another program that can replace the fault occurrence program. This prevents the same fault from occurring again when the cause of a fault is unidentified.

(2) The fault recovering portion distributes to a program executing device a program that can replace the fault occurrence program. This facilitates the installation of the other program.

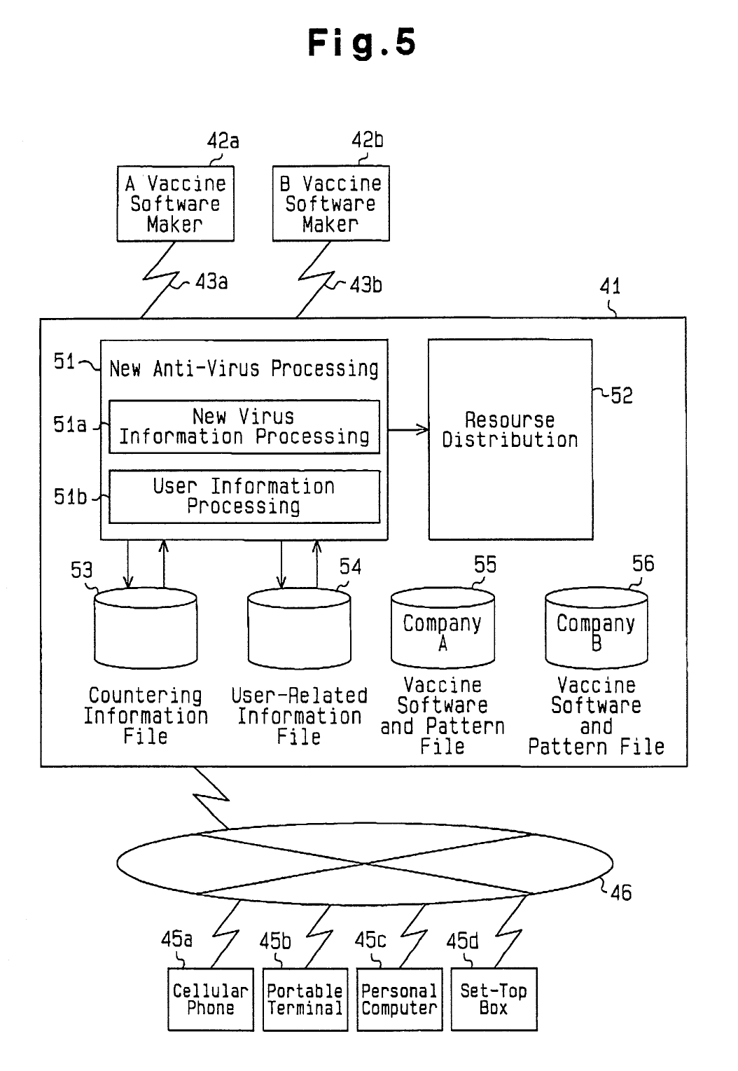

FIG. 5 is a schematic block diagram showing a client server system 200 according to a second embodiment of the present invention. An anti-virus program is used in the client server system 200.

Referring to FIG. 5, a server (hereafter referred to as maintenance server) 41 in a remote maintenance center is connected to support computers 42a, 42b of a number of vaccine software makers (in FIG. 5, two makers, which are company A and company B) through dedicated lines 43a, 43b. When required, the maintenance server 41 accesses the support computers 42a, 42b, obtains virus information and anti-virus information provided by each company, and stores each piece of information.

The virus information includes virus generation information provided by each company and virus countering information indicating how viruses are being countered. The anti-virus information includes updated vaccine software and pattern files that are provided by each company. The pattern files may also be referred to as pattern data files, signature files, or virus definition files.

In accordance with the circumstances under which viruses are generated, the maintenance server 41 registers and manages the information of new types of viruses. The information of the new virus includes, for example, virus name, danger level, discovery data, vaccine manufacture date (vaccine manufacture schedule), and the corresponding pattern file name (pattern number). The maintenance server 41 receives and stores updated vaccine software (including scan engines) and pattern data files that are provided by each company.

The support computers 42a, 42b of the vaccine software makers may upload vaccine software and pattern files to the maintenance server 41.

The maintenance server 41 is connected to various user terminals (in FIG. 5, four terminals) 45a, 45b, 45c, 45d by a public line 46, which includes the internet. The first terminal 45a is, for example, a cellular phone, and the second terminal 45b is, for example, a portable terminal such as a personal digital assistant (PDA) The third terminal 45c is, for example, a computer system of a personal computer, and the fourth terminal 45d is for example, a game device of a home communication terminal (set-top box) provided with a communication function.

The maintenance server 41 stores information related to the user terminals 45a-45d and, based on the user-related information, provides the terminals 45a-45d with updated vaccine software and pattern files.

The structure of the maintenance server 41 will now be discussed.

The maintenance server 41 includes a new anti-virus processing program 51, a resource distribution program 52, and information files 53, 54. The maintenance server 41 stores vaccine software and pattern files 55, 56 that are received from the vaccine software makers.

The new anti-virus processing program 51 includes a new virus information processing program 51a and a user information processing program 51b. The first information file 53 functions as a new virus countering information memory and stores vaccine software information (name of virus for which a vaccine has been produced, name of pattern file of virus for which a vaccine has been produced, name of virus for which a vaccine has not yet been produced, and danger level). The second information file 54 functions as a user information memory. The file 54 stores the present condition of the user terminal (information indicating the presently used vaccine software and whether to constantly update the vaccine software (including that of other manufacturers)).

When a new type of virus is generated, the new anti-virus information processing program 51a acquires new virus countering information from a plurality of vaccine software makers and stores the acquired information in the first information file 53. The user information processing program 51a acquires vaccine software-related information from the users and stores the acquired information in the second information file 54.

The user terminals 45a-45d are connected to the maintenance server 41 via the public line 46 when the user terminals 45a-45d are activated or at periodic intervals.

The new anti-virus processing program 51 acquires the vaccine software-related information from the second information file 54 via the user information processing program 51b. The processing program 51 acquires the new virus countering information that corresponds to the vaccine software-related information from the first information file 53 via the new virus information processing program 51a.

When the vaccine software used by the presently connected user terminal does not correspond to the new virus and the user wishes to constantly update the vaccine software (including that of other manufacturers), the new anti-virus processing program 51 provides the resource distribution program 52 with information for sending vaccine software corresponding to the new virus to the user terminal.

Based on the information received from the new anti-virus processing program 51, the resource distribution program 52 distributes vaccine software and pattern files that are updated to correspond to the new virus. Such processing installs updated vaccine software and pattern files in the user terminal and prevents the terminal from being infected by the new virus. In other words, damage that may be caused by a new virus is prevented.

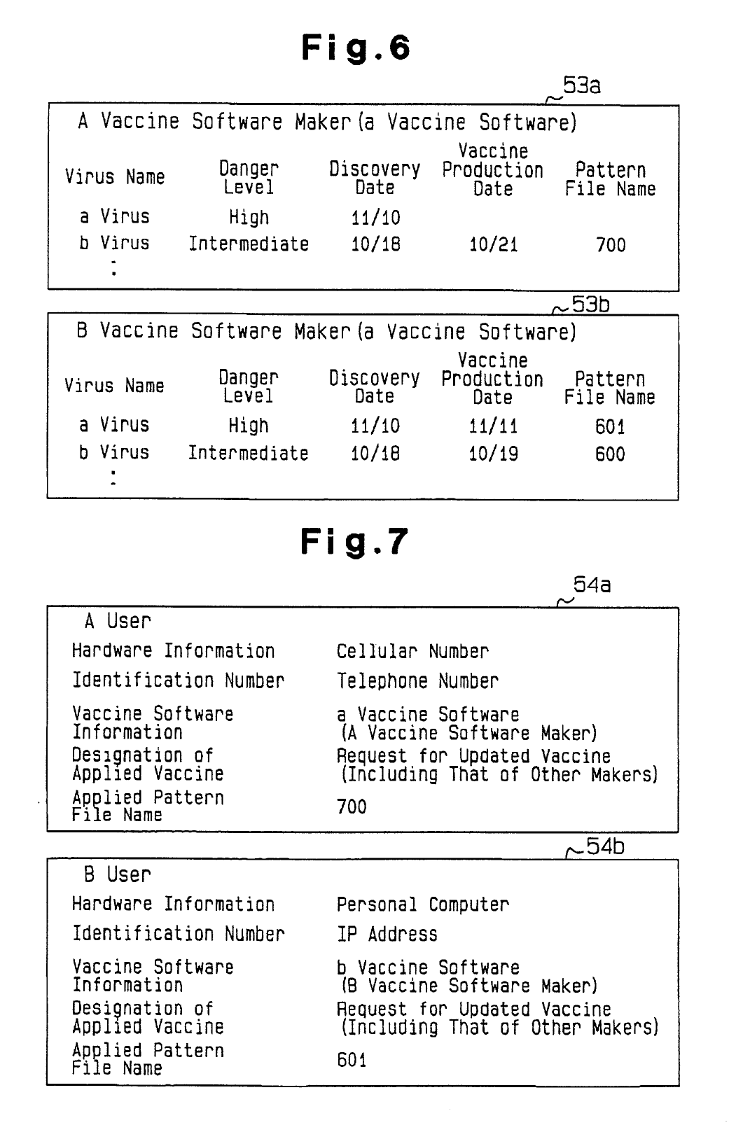

FIG. 6 is a table illustrating the virus countering information stored in the first information file 53.

First countering information 53a refers to information related to a vaccine software a, which is provided by registered vaccine software maker A. Second countering information 53b refers to a vaccine software b, which is provided by registered software maker B.

The information 53a, 53b respectively include information related with each discovered virus, such as virus name, danger level, discovery date, vaccine production date, and pattern file name. For example, virus a has a high danger level (causes a large system damage) and was discovered on November 10. Information related to the vaccine production date and the pattern file name are not stored for virus a in the first countering information 53a. This indicates that vaccine software maker A has not yet produced a vaccine for virus a. In comparison, information related to the vaccine production date and the pattern file name are stored for virus a in the second countering information 53b. This indicates that vaccine software maker B has produced a vaccine for virus a.

FIG. 7 is a table illustrating the user-related information stored in the second information file 54.

First user-related information 54a refers to information related to user A, who is registered. Second user-related information 54b refers to information related to user B, who is registered.

The information 54a, 54b respectively include information of the user's terminal, such as hardware information, identification number, vaccine software information, designation of applied vaccine, and applied pattern file name. For example, user A has the user terminal 45a (cellular phone), which is shown in FIG. 5, and vaccine software a, which is provided by vaccine software maker A, is installed in the user terminal 45a. As listed under “designation of applied vaccine,” user A wishes to receive updated vaccine, which includes that of other makers.

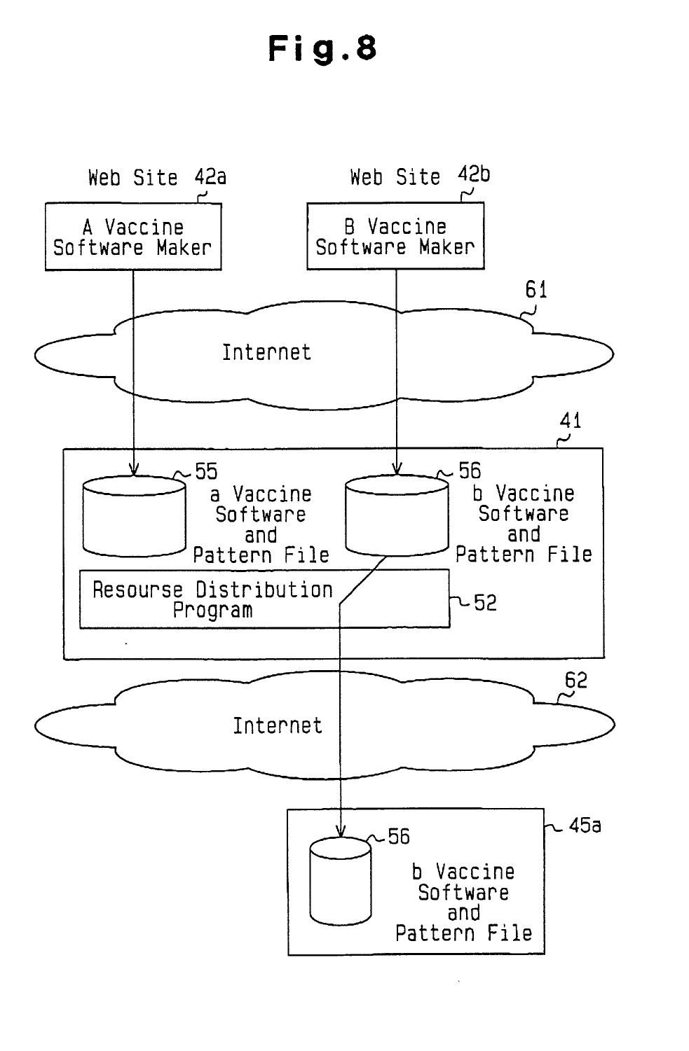

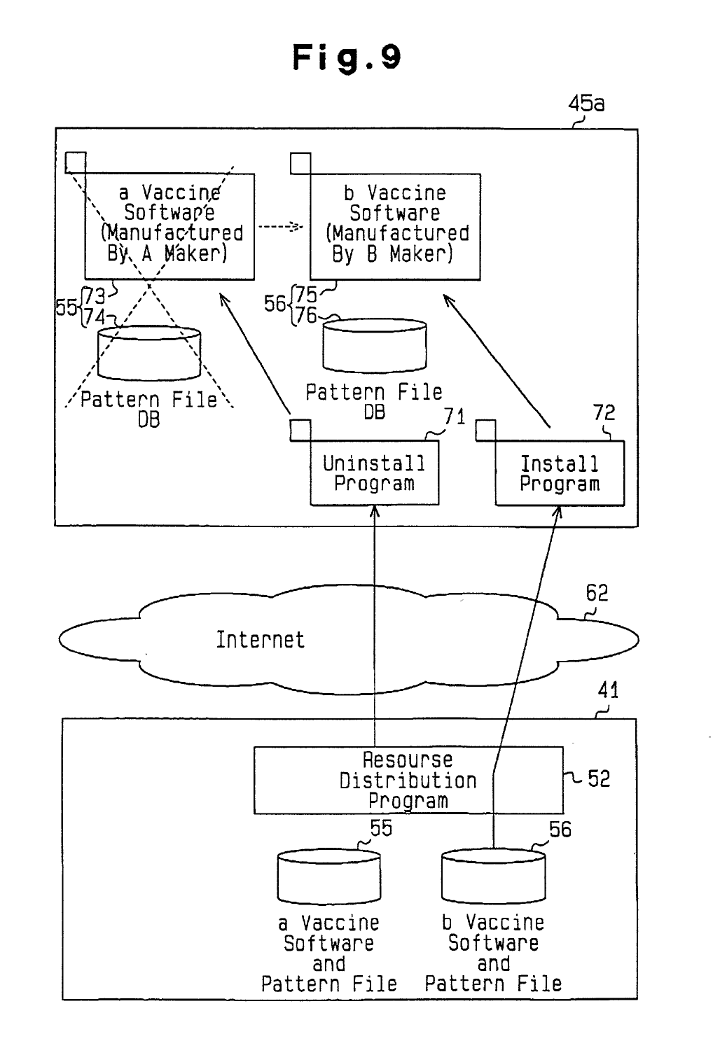

The distribution of the vaccine software and the pattern files by the maintenance server 41 will now be discussed with reference to FIGS. 8 and 9.

The virus countering information illustrated in FIG. 6 and the user-related information illustrated n FIG. 7 are stored in the first and second information files 53, 54 of FIG. 5.

[Vaccine Software and Pattern Files, Preparation of Various Information]

The maintenance server 41 performs steps S41 and S42, which are described below, to store various types of information.

In step S41, the new anti-virus processing program 51 reads the new anti-virus information processing program 51a, which registers and stores new anti-virus information provided from a vaccine software maker. The processing program 51a acquires virus countering information (e.g., virus name, danger level, discovery date, vaccine manufacture date, pattern file name) and stores the countering information in the first information file 53.

In step S42, the new anti-virus processing program 51 reads the user information processing program 51b, which registers and manages the user's vaccine software-related information. The processing program 51b acquires the software-related information from each user (e.g., hardware information, identification number, vaccine software information, designation of applied vaccine, applied pattern file name) and stores the software-related information in the second information file 54.

The support computers 42a, 42b of the vaccine software makers each occasionally provide the maintenance server 41 with vaccine software and pattern files via the associated dedicated lines 43a, 43b of FIG. 5. As shown in FIG. 8, the vaccine software and pattern files may be provided through the internet 61 from the website of each maker.

[Installation of Vaccine Software and Pattern Files]

The maintenance server 41 installs the vaccine software and pattern files in each of the user terminals 45a-45d by performing steps S51 to S56, which are described below.

For example, when user A activates the cellular phone 45a, the cellular phone 45a is connected to the maintenance server 41.

At step S51, the new anti-virus processing program 51 of the maintenance server 41 reads the user-related information 54a of user A from the second information file 54 by means of the user information processing program 51b.

At step S52, based on the vaccine software information included in the user-related information 54a, the anti-virus processing program 51 recognizes that the provider of the vaccine software used by the user A terminal (cellular phone) 45a is vaccine software maker A.

At step S53, the new anti-virus processing program 51 determines from the “vaccine manufacture date” and the “pattern file name” that the vaccine software of the vaccine software a has not been updated to counter the new virus (in this case, virus a).

At step S54, based on the determination of step S53, the new anti-virus processing program 51 acquires information that the user A wishes to obtain the most updated vaccine (including that of other makers) from the user-related information 54a of user A (FIG. 7). Based on the information, the anti-virus processing program 51 reads the countering information 53b (FIG. 6) of the B vaccine software maker from the first information file 53 by means of the new anti-virus information processing program 51a.

At step 555, the new anti-virus processing program 51 determines whether the vaccine software b of the vaccine software maker B is capable of countering the new virus from the countering information 53b. Thus, the new anti-virus processing program 51 transfers information to the resource distribution program 52 to install the vaccine software b of the vaccine software maker B to the user A cellular phone 45a.

At step S56, referring to FIG. 8, the resource distribution program 52 installs the vaccine software b and the pattern file 56 in the user A cellular phone 45a (FIG. 5) via a public line 46 (the internet 62 in FIG. 8) More specifically, referring to FIG. 9, the resource distribution program 52 automatically generates an uninstall program 71 and an install program 72 and loads the generated programs 71, 72 in the cellular phone 45a via the internet 62. The uninstall program 71 is a program (script) that deletes the vaccine software a and the pattern file (in FIG. 9, vaccine software 73 and pattern file DB 74) that are presently used by the cellular phone 45a. The install program 72 is a program (script) that installs the vaccine software b and the pattern file 56.

The uninstall program 71 loaded to the cellular phone 45a executes a script to delete the vaccine software a and the pattern file DB 74. The install program 72 loaded to the cellular phone 45a executes the install script to install the vaccine software b (75) and pattern file DB 76.

The client server system 200 of the second embodiment has the advantages described.

(1) The maintenance server 41 determines whether the vaccine software and pattern data files presently used by the user terminals 45a-45d are capable of countering a new virus from the countering information file 53 and the user-related information file 54. Based on the determination, the resource distribution program 52 distributes to the user terminals 45a-45d, vaccine software and pattern files (including that of other makers) that have been updated to counter the new virus.

(2) In accordance with the information of the designation of the applied vaccine stored in the second information file 54, the vaccine software and pattern file of another maker that has been updated to counter the new virus is installed in the user terminal. Thus, even if the used vaccine software has not been updated to counter a new virus, infection to the new virus is prevented.

(3) The resource distribution program 52 distributes vaccine software and pattern files to the user terminals. Thus, installation of the vaccine software and the pattern files is facilitated.

It should be apparent to those skilled in the art that the present invention may be embodied in many other specific forms without departing from the spirit or scope of the invention. Particularly, it should be understood that the present invention may be embodied in the following forms.

The maintenance server 41 may provide one or more vaccine software and pattern files from three or more vaccine software makers. Alternatively, the maintenance server 41 may provide the maintenance server 41 with a plurality of vaccine software and pattern files from a single vaccine software maker.

At step S55, the resource distribution program 52 may provide vaccine software information corresponding to a new virus to user A (e.g., vaccine software b that corresponds to the new virus, new virus name, danger level, and pattern file name) through a communication medium that is applicable to the user terminal. In the case of user A (cellular phone 45a), the communication medium may be an electronic mail sent though the internet or a carrier-exclusive electronic mail of the cellular phone 45a. When the maintenance server 41 receives a response from any of the user terminals 45a45d, the maintenance server 41 installs vaccine software and pattern files to the terminals 45a-45d that responded.

The dedicated lines 43a, 43b may be replaced by the internet 61 shown in FIG. 8 or a public line. A public line (including the public line 46 of FIG. 5) may be an analog or digital telephone line, a cable television network, or a satellite line.

The user terminal may be any kind of information device (system) that is capable of executing a program (script) and may be infected by a virus, such as a car navigation system or a vending machine (which is connected to the internet). The user terminal may also be a computer system used in a corporate, a public corporation, or an ISP/ASP enterprise.

At least one of the vaccine software and the pattern file may be installed in the user terminals 45a-45d. Further, a virus search section (also referred to as virus search engine) may be installed in the user terminals 45a45d.

The uninstall program 71, the install program 72, the vaccine software, and the pattern file may be installed in each of the terminals 45a-45d combined as one or more modules or divided into segments.

The vaccine software of the terminals 45a-45d may be replaced by updated software during a predetermined time period (e.g., late at night when the terminal is most likely not used).

When vaccine software and pattern files that have been updated to counter new types of viruses are stored in the maintenance server 41, the vaccine software and pattern files that are to be installed may be selected based on how vaccine makers have handled new viruses in the past (e.g., number of days until manufacturing a vaccine, the number of viruses that have been coped with).

The present examples and embodiments are to be considered as illustrative and not restrictive, and the invention is not to be limited to the details given herein, but may be modified within the scope and equivalence of the appended claims.

What is claimed is:

1. A method for providing virus vaccine software to a user terminal with a maintenance server that includes a first memory for storing information related to how a new virus is countered and a second memory for storing user information, the method comprising:
receiving virus countering information from a terminal of at least one vaccine software maker and storing the received virus countering information in the first memory;
receiving vaccine software-related information from at least one user terminal and storing the received vaccine software-related information in the second memory;
receiving the vaccine software-related information of a user from the second memory;
receiving new virus countering information from the first memory based on the vaccine software-related information; and
distributing vaccine software that corresponds to the new virus to the user terminal when the vaccine software presently used by the user terminal does not correspond to the new virus and the user wishes to be provided with updated vaccine software.

2. The method according to claim 1, further comprising:
automatically generating an uninstall program for deleting the vaccine software in the user terminal and an install program for installing the distributed new vaccine software in the user terminal.

3. The method according to claim 1, wherein the step of receiving new virus countering information is performed when a new virus is generated in the user terminal.

4. The method according to claim 1, further comprising:
determining whether the vaccine software used by the user terminal corresponds to the new virus when the user terminal is activated or at a predetermined time.

5. The method according to claim 2, wherein the step of receiving new virus countering information is performed when a new virus is generated in the user terminal.

6. The method according to claim 5, further comprising;
determining whether the vaccine software used by the user terminal corresponds to the new virus when the user terminal is activated or at a predetermined time.

7. A program for operating a computer that provides virus vaccine software to at least one user terminal, the program causing the computer to define:
a first memory means for receiving virus countering information from a terminal of at least one vaccine software maker and storing the received virus countering information;
a second memory means for receiving vaccine software-related information from at least one user terminal and storing the received vaccine software-related information;
a new anti-virus processing means for receiving the vaccine software-related information of the user terminal from the second memory means and receiving the new virus countering information from the first memory means based on the received vaccine software-related information, wherein the new anti-virus processing means generates information to distribute to the user terminal updated vaccine software corresponding to the new virus when the vaccine software presently used by the user terminal does not correspond to the new virus and the user wishes to be provided with the updated vaccine software; and
a resource distributing means for receiving the information from the new anti-virus processing means and distributing the updated vaccine software that corresponds to the new virus based on the information.

8. The program according to claim 7, wherein the resource distributing means automatically generates an uninstall program for deleting the vaccine software in the user terminal and an install program for installing the distributed new vaccine software in the user terminal.

9. The program according to claim 8, wherein the new anti-virus processing means includes:
a new virus information processing means for acquiring virus countering information from a terminal of at least one vaccine software maker and storing the acquired virus countering information in the first memory means; and
a user information processing mans for acquiring vaccine software-related information from the user terminal and storing the acquired vaccine software-related information in the second memory.

10. The program according to claim 9, wherein the new virus information processing means acquires the virus countering information from at least one vaccine software maker when a new virus is generated in the user terminal.

11. The program according to claim 10, wherein the new virus information processing means determines whether the vaccine software used by the user terminal corresponds to the new virus when the user terminal is activated or at a predetermined time.

12. The program according to claim 7, wherein the new anti-virus processing means includes:
a new virus information processing means for acquiring virus countering information from a terminal of at least one vaccine software maker and storing the acquired virus countering information in the first memory means; and
a user information processing mans for acquiring vaccine software-related information from the user terminal and storing the acquired vaccine software-related information in the second memory.

13. The program according to claim 7, wherein the new virus information processing means acquires the virus countering information from at least one vaccine software maker when a new virus is generated in the user terminal.

14. The program according to claim 7, wherein the new virus information processing means determines whether the vaccine software used by the user terminal corresponds to the new virus when the user terminal is activated or at a predetermined time.

15. A method for providing a virus software to at least one user terminal using a first memory for storing information related to how a new virus is countered and a second memory for storing user information, the method comprising:
receiving virus countering information from a terminal of at least one vaccine software maker and storing the received virus countering information in the first memory;
receiving vaccine software-related information of a user from the user terminal and storing the received vaccine software-related information in the second memory;
receiving the vaccine software-related information from the second memory;
receiving new virus countering information from the first memory based on the vaccine software-related information;
distributing vaccine software that corresponds to the new virus to the user terminal when the vaccine software presently used by the user terminal does not correspond to the new virus and the user wishes to be provided with updated vaccine software.

16. A method for recovering from a fault when a fault occurs during execution of a first program, the method comprising:
receiving fault-related information from the computer executing the first program;
investigating a cause of the fault from the fault-related information; and
instructing the computer to replace the first program with a second program when the cause of the fault is unidentified.

17. The method according to claim 16, further comprising:
distributing the second program to the computer.

18. A system for recovering from a fault when a fault occurs during the execution of a first program, the system comprising:
a fault recovery portion for receiving fault-related information from a computer, wherein the fault recovery portion investigates a cause of the fault from the fault-related information and instructs the computer to replace the first program with a second program when the cause of the fault is unidentified.

19. The system according to claim 18, wherein the fault recovery portion distributes the second program to the computer.

20. A recording medium for recording a computer readable fault recovery program that sends fault recovery information to a computer when a fault occurs in the computer during execution of a first program, the fault recovery program comprising:
receiving fault-related information from the computer;
investigating a cause of the fault from the fault-related information; and
sending information instructing the computer to replace the first program with a second program when the cause of the fault is unidentified as the fault recovery information.
